(19) United States
(12) Patent Application Publication
(10) Pub. No.: US 2013/0154899 A1
(43) Pub. Date: Jun. 20, 2013

(54) APERIODIC DISTRIBUTION OF APERTURE ELEMENTS IN A DUAL BEAM ARRAY

(71) Applicant: William Lynn Lewis, III, Redondo Beach, CA (US)

(72) Inventor: William Lynn Lewis, III, Redondo Beach, CA (US)

(21) Appl. No.: 13/330,585

(22) Filed: Dec. 19, 2011

(51) Int. Cl. H01Q 21/00

(52) U.S. Cl. 343/893

(57) ABSTRACT

An antenna array includes a plurality of apertures arranged within a uniform lattice and adapted to radiate at least two beams in different frequency bands in arbitrary pointing directions. A first aperture group and a second aperture group of the plurality of apertures are adapted to radiate a first beam and a second beam of the at least two beams, respectively. The first aperture group and the second aperture group are substantially coextensive, and the apertures of each of the first and second aperture groups are aperiodically distributed among the uniform lattice.

### FIELD

Aspects of embodiments according to the present invention relate to antenna arrays and, particularly, active antenna arrays capable of radiating multiple beams.

### BACKGROUND

An antenna array may be implemented by using an active antenna array that includes a group of multiple active apertures (or elements) arranged in a uniform lattice to produce a radiation beam pattern that can be directed or steered. The spatial relationship of the individual apertures contributes to the directivity of the antenna array, and the effective radiation pattern of the array is determined by the relative amplitudes and phases of the signals radiated by the individual apertures. Therefore, an active antenna array may be used to project a fixed radiation pattern to a desired direction or to electronically scan in azimuth and/or elevation by adjusting the signals radiated by the individual apertures. However, to reduce costs and physical size, it is desirable to provide a multi-function radar system utilizing a single active antenna array. For example, it is desirable to have an antenna array that is capable of producing multiple beams using a single shared array. However, prior known solutions suffer from loss of sensitivity, increased peak sidelobes, and do not conform to typical uniform lattice applications.

### SUMMARY

Aspects of embodiments according to the present invention are directed toward an antenna array that is capable of simultaneously radiating two or more beams from a single shared array without significantly increased sidelobes and reduction of area gain.

According to an embodiment of the present invention, an antenna array includes a plurality of apertures arranged at a uniform lattice and adapted to radiate at least two beams in different frequency bands. A first aperture group and a second aperture group of the plurality of apertures are adapted to radiate a first beam and a second beam of the at least two beams, respectively. The first aperture group and the second aperture group are substantially coextensive, and the apertures of each of the first and second aperture groups are aperiodically distributed among the uniform lattice.

According to an embodiment, the antenna array may be adapted to radiate the first beam and the second beam simultaneously in arbitrary pointing directions.

According to an embodiment, the apertures may be allocated to radiate the first beam or the second beam in accordance with a pseudo-random sequence. The pseudo-random sequence may be a pseudo-noise maximum length sequence.

According to an embodiment, the apertures may be allocated to radiate the first beam or the second beam in accordance with a first pseudo-random sequence in a first dimension of the antenna array. The apertures may be allocated to radiate the first beam or the second beam in accordance with a second pseudo-random sequence in a second dimension of the antenna array. The apertures may be allocated to radiate the first beam or the second beam in accordance with a two-dimensional pseudo-random sequence.

According to an embodiment of the present invention, a method is provided to operate an antenna array including a plurality of apertures arranged at a uniform lattice. A first beam is radiated at a first frequency band using a first aperture group of the plurality of apertures, and a second beam is radiated at a second frequency band using a second aperture group of the plurality of apertures. The first aperture group and the second aperture group are substantially coextensive, and the apertures of each of the first and second aperture groups are aperiodically distributed among the uniform lattice. The first beam and the second beam may be simultaneously radiated.

The method may include allocating the apertures to radiate the first beam or the second beam in accordance with a pseudo-random sequence. The method may include allocating the apertures to radiate the first beam or the second beam in accordance with a first pseudo-random sequence in a first dimension of the antenna array. The method may further include allocating the apertures to radiate the first beam or the second beam in accordance with a second pseudo-random sequence in a second dimension of the antenna array. The method may include allocating the apertures to radiate the first beam or the second beam in accordance with a two-dimensional pseudo-random sequence.

According to an embodiment of the present invention, an antenna array includes a first group of apertures adapted to radiate a first beam at a first frequency and a second group of apertures adapted to radiate a second beam at a second frequency. The first beam and the second beam are radiated simultaneously, and the first aperture group and the second aperture group are substantially coextensive and are aperiodically distributed among a uniform lattice of the antenna array. The first group of apertures and the second group of apertures may be distributed among the uniform lattice in accordance with a pseudo-random sequence. The first group of apertures and the second group of apertures may be distributed among the uniform lattice in accordance with a two-dimensional pseudo-random sequence.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a drawing conceptually illustrating a dual beam half and half shared antenna array.

FIG. 2 is a drawing conceptually illustrating a dual beam periodic interleaved antenna array.

FIG. 3 is a drawing conceptually illustrating an aperiodic distribution of a row of apertures according to an example embodiment of the present invention.

FIG. 4 is a drawing conceptually illustrating a two-dimensional aperiodic distribution of apertures according to an example embodiment of the present invention.

FIG. 5 is a graph illustrating the beam patterns for a comparative shared array, a comparative periodic distribution array, and an aperiodic distribution array.

FIG. 6 is an enlarged view of a portion of the beam pattern in FIG. 5.

FIG. 7 is a block diagram illustrating a method of operating an antenna array according to an embodiment of the present invention.

### DESCRIPTION OF EMBODIMENTS

Hereinafter, certain exemplary embodiments according to the present invention will be described with reference to the accompanying drawings. Embodiments of the present invention are directed toward an antenna array and a method of operating an antenna array that reduce typical antenna sensitivity degradation associated with aperture sharing and to reduce increased peak sidelobe levels associated with periodic interleaving of apertures. Example embodiments of the present invention are directed toward an antenna array of a radar system that can provide dual simultaneous arbitrary (angle, frequency) beam operation utilizing a single active antenna array. However, the inventive concept of the present invention is not limited to dual simultaneous beam operation. To the contrary, the present invention may be embodied in a single active antenna array that can operate with three or even more simultaneous arbitrary beams. The example embodiments of the present invention can be realized within the constraint of a fixed lattice array with uniform or periodic spacing that supports scan at the highest center frequency (e.g., grid spacing of 0.5 wavelength).

In the related art, typical dual beam radar systems either time-multiplex beams or simply increase the aperture area to accommodate simultaneous arrays. However, simultaneous multi-beam operation typically degrades antenna sensitivity of the array due to the reduction in transmitting apertures (one way loss) and area gain (two way loss).

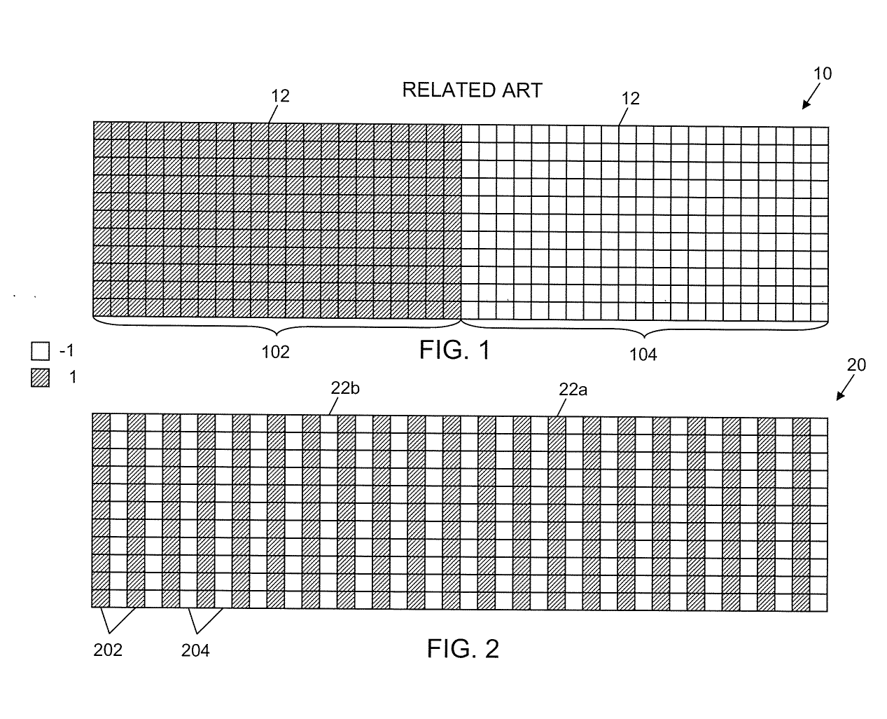

FIG. 1 is a drawing conceptually illustrating a dual beam half and half shared antenna array 10 that includes a plurality of apertures 12 arranged at a uniform lattice according to the related art. The apertures 12 are divided into two separate areas 102 and 104 to respectively radiate two beams at different frequencies. In FIG. 1, the apertures 12 (i.e., shaded cells “1”) at the left half 102 of the antenna array 10 are allocated to radiate a first beam, and the apertures 12 (i.e., clear cells “−1”) at the right half 104 of the antenna array 10 are allocated to radiate a second beam. Here, although the antenna array 10 shown in FIG. 1 can be operated to provide the first and second beams simultaneously, the antenna array 10 has reduced area gain with respect to each of the two beams because each beam is radiated using only half of the effective size of the antenna array 10.

FIG. 2 is a drawing conceptually illustrating a dual beam periodic interleaved antenna array 20 that includes a plurality of apertures (22a and 22b) arranged at a uniform lattice according to the related art. The apertures are divided into two interleaved groups 202 and 204 to respectively radiate two beams at different frequencies. In FIG. 2, the apertures 22a (i.e., shaded cells “1”) of the group 202 are allocated to radiate a first beam, and the apertures 22b (clear cells “−1”) of the group 204 are allocated to radiate a second beam. Here, although the antenna array 20 shown in FIG. 2 can be operated to provide the first and second beams simultaneously, the antenna array 20 suffers from increased peak sidelobe levels associated with periodic interleaving of apertures. Therefore, a periodic interleaving of apertures may solve the area gain problem, but at the cost of increased sidelobe levels (e.g., grating lobes).

Different from the related art, embodiments of the present invention solve the above discussed problems by allocating array apertures or elements into either one band or the other in a spatial distribution that is relatively prime to each other in each dimension. The relatively prime property preserves the original aperture or element spacing density and reduces the likelihood of columnated lobes related to integer multiples of the array element spacing. For example, the spatial distribution of the apertures may be determined by using well understood aperiodic sequence approach in a dual beam application.

According to an embodiment of the present invention, the apertures of an antenna array may be distributed in an aperiodic lattice according to a pseudo-random sequence such as a pseudo-noise maximum length sequence. However, the present invention is not limited thereto. That is, the apertures may be distributed according to other suitable sequences.

In some embodiments of the present invention, the apertures may be distributed according to a maximum length sequence (MLS) that can be generated using maximal linear feedback shift registers (i.e., for length-m registers they produce a sequence of length 2^{m}−1). A MLS is also sometimes called a n-sequence or a m-sequence. A linear feedback shift register is a shift register whose input bit is a linear function of its previous state.

### Example Sequences

| | length = 39 | length = 35 | length = 143 | length = 64 |
|---|---|---|---|---|
| 1 | 1 | 1 | 1 | 1 |
| 2 | 1 | 1 | 1 | 1 |
| 3 | 1 | −1 | 1 | 1 |
| 4 | −1 | 1 | 1 | −1 |
| 5 | 1 | 1 | 1 | −1 |
| 6 | 1 | −1 | −1 | −1 |
| 7 | −1 | −1 | 1 | 1 |
| 8 | −1 | 1 | 1 | 1 |
| 9 | 1 | −1 | 1 | 1 |
| 10 | −1 | 1 | 1 | 1 |
| 11 | 1 | −1 | −1 | −1 |
| 12 | 1 | 1 | −1 | 1 |
| 13 | −1 | 1 | 1 | 1 |
| 14 | 1 | 1 | 1 | −1 |
| 15 | −1 | 1 | 1 | 1 |
| 16 | −1 | −1 | −1 | 1 |
| 17 | 1 | 1 | 1 | 1 |
| 18 | −1 | 1 | −1 | 1 |
| 19 | −1 | −1 | 1 | 1 |
| 20 | −1 | −1 | 1 | −1 |
| 21 | 1 | −1 | −1 | 1 |
| 22 | −1 | 1 | 1 | 1 |
| 23 | 1 | −1 | −1 | −1 |
| 24 | −1 | −1 | 1 | 1 |
| 25 | −1 | −1 | 1 | 1 |
| 26 | 1 | −1 | 1 | 1 |
| 27 | 1 | −1 | 1 | 1 |
| 28 | −1 | 1 | 1 | −1 |
| 29 | −1 | 1 | 1 | −1 |
| 30 | −1 | 1 | −1 | −1 |
| 31 | −1 | −1 | −1 | 1 |
| 32 | −1 | −1 | −1 | 1 |
| 33 | 1 | −1 | 1 | 1 |
| 34 | −1 | 1 | −1 | −1 |
| 35 | −1 | −1 | −1 | 1 |
| 36 | −1 | | −1 | −1 |
| 37 | −1 | | 1 | 1 |
| 38 | −1 | | −1 | −1 |
| 39 | −1 | | 1 | −1 |
| 40 | | | 1 | −1 |
| 41 | | | −1 | −1 |
| 42 | | | 1 | 1 |
| 43 | | | 1 | −1 |
| 44 | | | −1 | −1 |
| 45 | | | −1 | 1 |
| 46 | | | −1 | 1 |
| 47 | | | 1 | 1 |
| 48 | | | −1 | −1 |
| 49 | | | 1 | 1 |
| 50 | | | 1 | 1 |
| 51 | | | 1 | −1 |
| 52 | | | −1 | 1 |
| 53 | | | 1 | 1 |
| 54 | | | 1 | 1 |
| 55 | | | 1 | −1 |
| 56 | | | −1 | −1 |
| 57 | | | 1 | 1 |
| 58 | | | 1 | −1 |
| 59 | | | −1 | −1 |
| 60 | | | −1 | −1 |
| 61 | | | −1 | −1 |
| 62 | | | −1 | 1 |
| 63 | | | −1 | −1 |
| 64 | | | 1 | 1 |
| 65 | | | 1 | −1 |
| 66 | | | 1 | |
| 67 | | | −1 | |
| 68 | | | −1 | |
| 69 | | | −1 | |
| 70 | | | 1 | |
| 71 | | | −1 | |
| 72 | | | −1 | |
| 73 | | | 1 | |
| 74 | | | 1 | |
| 75 | | | −1 | |
| 76 | | | 1 | |
| 77 | | | 1 | |
| 78 | | | −1 | |
| 79 | | | 1 | |
| 80 | | | −1 | |
| 81 | | | −1 | |
| 82 | | | 1 | |
| 83 | | | 1 | |
| 84 | | | 1 | |
| 85 | | | 1 | |
| 86 | | | 1 | |
| 87 | | | −1 | |
| 88 | | | −1 | |
| 89 | | | −1 | |
| 90 | | | −1 | |
| 91 | | | −1 | |
| 92 | | | 1 | |
| 93 | | | 1 | |
| 94 | | | −1 | |
| 95 | | | −1 | |
| 96 | | | −1 | |
| 97 | | | 1 | |
| 98 | | | −1 | |
| 99 | | | 1 | |
| 100 | | | −1 | |
| 101 | | | 1 | |
| 102 | | | −1 | |
| 103 | | | −1 | |
| 104 | | | 1 | |
| 105 | | | 1 | |
| 106 | | | −1 | |
| 107 | | | 1 | |
| 108 | | | −1 | |
| 109 | | | 1 | |
| 110 | | | 1 | |
| 111 | | | −1 | |
| 112 | | | −1 | |
| 113 | | | 1 | |
| 114 | | | 1 | |
| 115 | | | 1 | |
| 116 | | | −1 | |
| 117 | | | −1 | |
| 118 | | | 1 | |
| 119 | | | −1 | |
| 120 | | | −1 | |
| 121 | | | −1 | |
| 122 | | | −1 | |
| 123 | | | −1 | |
| 124 | | | 1 | |
| 125 | | | −1 | |
| 126 | | | −1 | |
| 127 | | | 1 | |
| 128 | | | −1 | |
| 129 | | | 1 | |
| 130 | | | −1 | |
| 131 | | | 1 | |
| 132 | | | −1 | |
| 133 | | | −1 | |
| 134 | | | 1 | |
| 135 | | | −1 | |
| 136 | | | −1 | |
| 137 | | | −1 | |
| 138 | | | −1 | |
| 139 | | | 1 | |
| 140 | | | −1 | |
| 141 | | | −1 | |
| 142 | | | −1 | |
| 143 | | | −1 | |

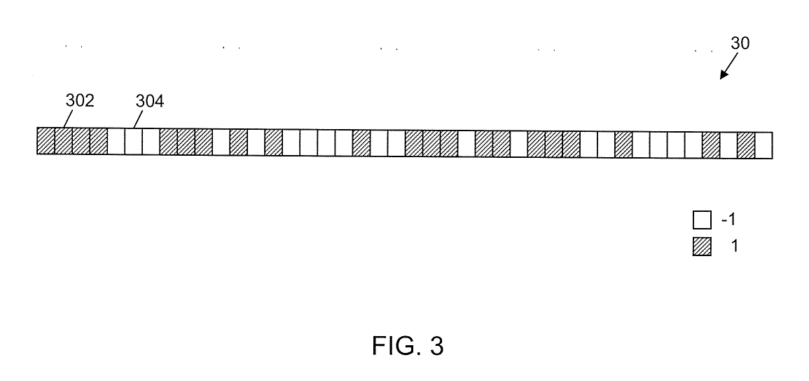

FIG. 3 is a drawing conceptually illustrating an aperiodic distribution of a row of apertures 30 according to an example embodiment of the present invention. In FIG. 3, the apertures 30 along the row are distributed according to a one-dimensional example of a pseudo-noise distribution to radiate two beams simultaneously in arbitrary pointing directions. The apertures 302 (denoted by “1”) are used to radiate a first beam, and the apertures 304 (denoted by “−1”) are used to radiate a second beam. This class of sequences has the desirable property of strong autocorrelation in order to maintain mainlobe width with better sidelobe performance than random sequences.

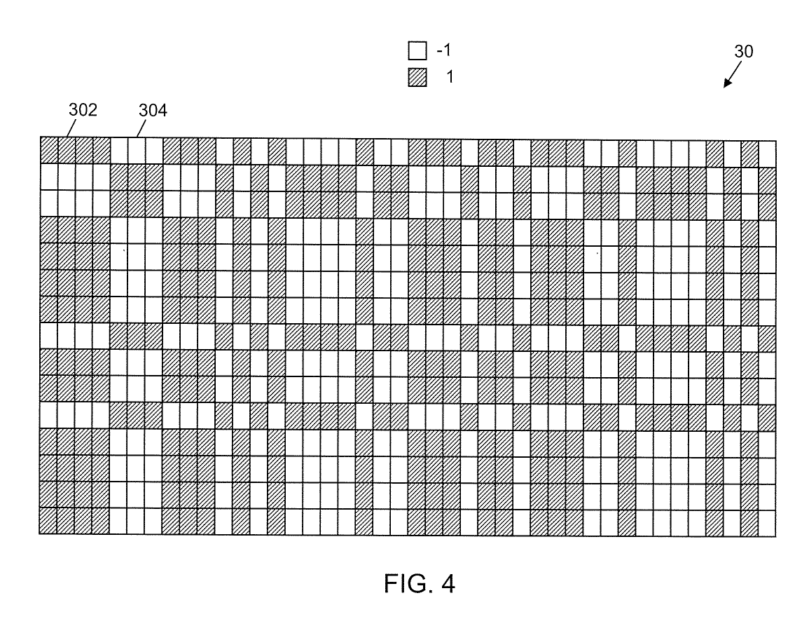

FIG. 4 is a drawing conceptually illustrating a two-dimensional aperiodic distribution of apertures 30 according to an example embodiment of the present invention. In FIG. 4, the one-dimensional distribution of the apertures 30 in FIG. 3 is extended to two dimensions. In the row direction, the apertures 30 are distributed according to a first one-dimensional sequence. In the column direction, the apertures 30 are distributed according to a second one-dimensional sequence. Accordingly, the apertures 30 shown in FIG. 4 have a two-dimensional aperiodic distribution among a uniform lattice. However, the present invention is not limited to using a one-dimensional sequence. In other example embodiments, the apertures may be distributed according to a suitable two-dimensional sequence. In the embodiment of FIG. 4, the two one-dimensional sequences applied to generate the two-dimensional aperiodic distribution are uncoupled. However, in other embodiments of the present invention, coupled sequences may be used.

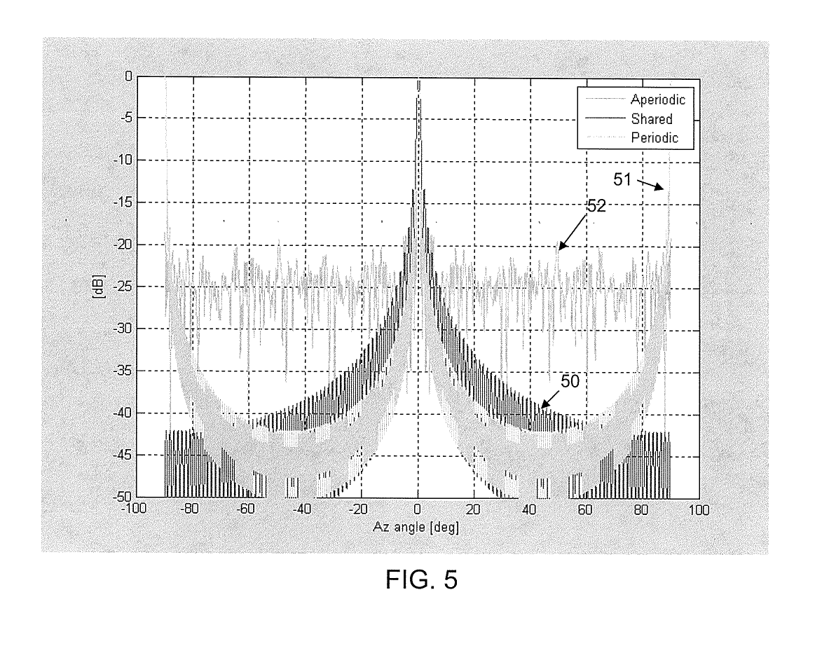

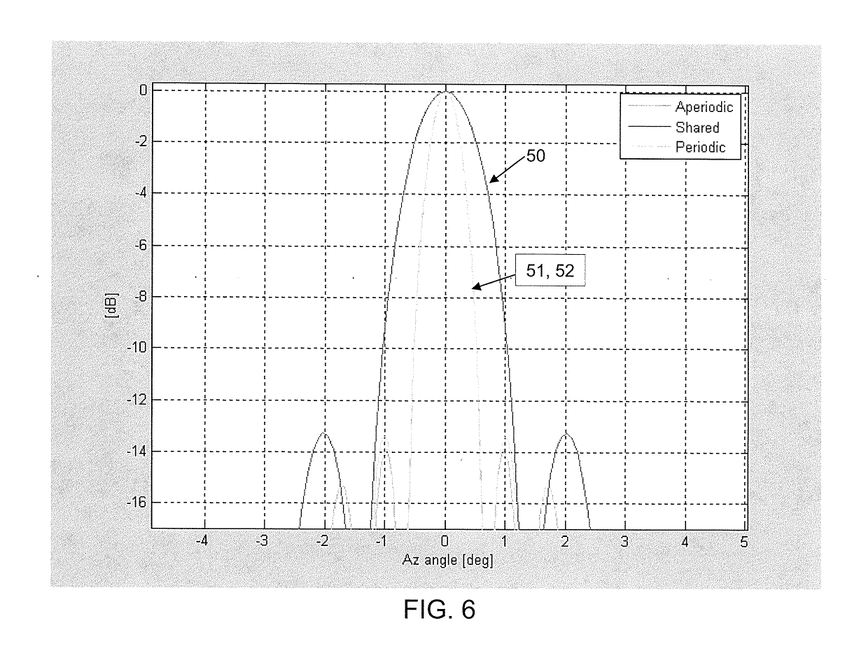

FIG. 5 is a graph illustrating the beam patterns for a comparative shared array 50, a comparative periodic distribution array 51, and an aperiodic distribution array 52. In FIG. 5, the beam pattern of the aperiodic distribution array 52 corresponds to the one dimension array 30 shown in FIG. 3 according to an embodiment of the present invention. The beam pattern of the shared array 50 corresponds to the array configuration shown in FIG. 1, and the beam pattern of the periodic distribution array 51 corresponds to the array configuration shown in FIG. 2. FIG. 6 is an enlarged view of portions of the mainlobes and sidelobes of the beam patterns shown in FIG. 5.

As shown in FIG. 5, the shared array has excellent sidelobes but with a factor of two degradation in beamwidth and directivity (i.e., area gain). The beam pattern for the periodic distribution array maintains beamwidth and directivity relative to the full aperture but has very large localized peak sidelobes (at 90 degree relative to mainlobe). The aperiodic distribution array of the present invention, however, maintains beamwidth and directivity relative to the full aperture but with no apparent grating lobes and an overall increase in the average sidelobe level. Thus, the aperiodic distribution array offers the ability to trade average sidelobe performance for peak sidelobe performance while maintaining aperture gain and beamwidth.

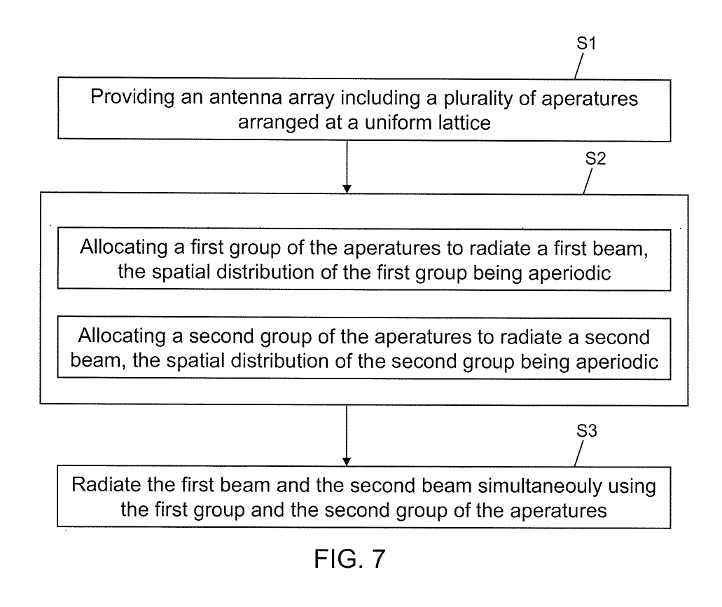

FIG. 7 is a block diagram illustrating a method of operating an antenna array according to an embodiment of the present invention. The antenna array includes a plurality of apertures arranged at a uniform lattice. (Block S1). A first group of the apertures are allocated to radiate a first beam, and the spatial distribution of the first group within the uniform lattice is aperiodic. (Block S2). A second group of the apertures are allocated to radiate a second beam, and the spatial distribution of the second group within the uniform lattice is aperiodic. (Block S2). The effective antenna area of the first group and the effective antenna area of the second group are substantially coextensive. The first beam is radiated at a first frequency using the first group, and the second beam is radiated at a second frequency using the second group. Here, the first beam and the second beam may be radiated simultaneously. (Block S3). It will be appreciated that the present invention is applicable to the typical transmit signals that are utilized in, for example, Pulse Doppler Radar such as linear frequency modulated, phase modulated, or uncoded RF pulses. However, the utility for the present invention is not dependent on nor is it constrained to radar applications.

In yet another embodiment of the present invention, a radar system includes an active antenna array as discussed in the above embodiments, and the active antenna array is driven by suitable active radar circuitries. For example, a multifunction active array system is disclosed in U.S. Pat. No. 4,792,805, the entire content of which is hereby incorporated by reference.

There has been a fair amount of work with regard to applying aperiodic distributions in active arrays for the purposes of realizing near full performance by using “thinned” or sparse arrays. However, the motivation in the past has been to reduce consumption of prime power and therefore improve overall antenna efficiency. Unlike the prior work, the embodiments of the present invention apply relative aperiodic sequences to dual bands or beams within an array in order to provide pure simultaneity with optimal radar performance. Additionally, the embodiments and method of the present invention are compatible with uniform lattice arrays that are often used in airborne radar systems. For example, embodiments of the present invention have the ability to provide simultaneous search capability (lower band beam) and track (higher band beam) to minimize scan coverage time and improve probability of intercept/detection/ID over time. Furthermore, the concept of the present invention can be extended to N simultaneous beams, especially if the additional beams are of longer wavelength.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. An antenna array comprising:
a plurality of apertures arranged at a uniform lattice and adapted to radiate at least two beams in different frequency bands, wherein:
a first aperture group and a second aperture group of the plurality of apertures are adapted to radiate a first beam and a second beam of the at least two beams, respectively;
the first aperture group, and the second aperture group are substantially coextensive; and
the apertures of each of the first and second aperture groups are aperiodically distributed among the periodic lattice.

2. The antenna array of claim 1, wherein the antenna array is adapted to radiate the first beam and the second beam simultaneously in arbitrary pointing directions.

3. The antenna array of claim 1, wherein the apertures are allocated to radiate the first beam or the second beam in accordance with a pseudo-random sequence.

4. The antenna array of claim 3, wherein the pseudo-random sequence is a pseudo-noise maximum length sequence.

5. The antenna array of claim 3, wherein the apertures are allocated to radiate the first beam or the second beam in accordance with a first pseudo-random sequence in a first dimension of the antenna array.

6. The antenna array of claim 5, wherein the apertures are allocated to radiate the first beam or the second beam in accordance with a second pseudo-random sequence in a second dimension of the antenna array.

7. The antenna array of claim 1, wherein the apertures are allocated to radiate the first beam or the second beam in accordance with a two-dimensional pseudo-random sequence.

8. A method of operating an antenna array comprising a plurality of apertures arranged at a uniform lattice, the method comprising: radiating a first beam at a first frequency band using a first aperture group of the plurality of apertures; and
radiating a second beam rat a second frequency band using a second aperture group of the plurality of apertures,
wherein the first aperture group and the second aperture group are substantially coextensive, and the apertures of each of the first and second aperture groups are aperiodically distributed among the periodic lattice.

9. The method of claim 8, wherein the first beam and the second beam are simultaneously radiated.

10. The method claim 8, further comprising allocating the apertures to radiate the first beam or the second beam in accordance with a pseudo-random sequence.

11. The method of claim 10, wherein the pseudo-random sequence is a pseudo-noise maximum length sequence.

12. The method of claim 10, wherein allocating the apertures comprises allocating the apertures to radiate the first beam or the second beam in accordance with a first pseudo-random sequence in a first dimension of the antenna array.

13. The method of claim 12, wherein allocating the apertures further comprises allocating the apertures to radiate the first beam or the second beam in accordance with a second pseudo-random sequence in a second dimension of the antenna array.

14. The method of claim 8, further comprising allocating the apertures to radiate the first beam or the second beam in accordance with a two-dimensional pseudo-random sequence.

15. An antenna array comprising:
a first group of apertures adapted to radiate a first beam at a first frequency; and
a second group of apertures adapted to radiate a second beam at a second frequency, the first beam and the second beam being radiated simultaneously,
wherein the first aperture group and the second aperture group are substantially coextensive and are aperiodically distributed among a uniform lattice of the antenna array.

16. The antenna array of claim 15, wherein the first group of apertures and the second group of apertures are distributed among the uniform lattice in accordance with a pseudo-random sequence.

17. The antenna array of claim 16, wherein the pseudo-random sequence is a pseudo-noise maximum length sequence.

18. The antenna array of claim 16, wherein the first group of apertures and the second group of apertures are distributed among the uniform lattice in accordance with a two-dimensional pseudo-random sequence.
